(19) United States
(12) Patent Application Publication
(10) Pub. No.: US 2015/0072069 A1
(43) Pub. Date: Mar. 12, 2015

(54) ASSEMBLY AND METHOD FOR OPTICALLY OPTIMIZED HIGH-POWER LED DEVICES

(71) Applicant: MICHAEL D. CALLAGHAN, Minneapolis, MN (US)

(72) Inventor: MICHAEL D. CALLAGHAN, Minneapolis, MN (US)

(21) Appl. No.: 14/473,175

(22) Filed: Aug. 29, 2014

Related U.S. Application Data
(60) Provisional application No. 61/871,376, filed on Aug. 29, 2013.

(51) Int. Cl. F21V 14/04; F21V 7/06

(52) U.S. Cl. CPC F21V 14/04; F21V 7/06
USPC 427/8; 362/276

(57) ABSTRACT

A method of optimizing a reflector and light source by cyclically altering a configuration of the reflector or a distance between the reflector and the light source until light intensity is maximized or until scattered light is minimized. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 C.F.R. §1.72(b).

### CROSS-REFERENCES TO RELATED APPLICATIONS

This application claims priority under 35 U.S.C. §119 (e) to, and hereby incorporates by reference, U.S. Provisional Application No. 61/871,376, filed 29 Aug. 2013.

### BACKGROUND OF THE INVENTION

1. Field of the Invention

This invention relates to light emitting diode (LED) devices and, in particular, this invention relates to optimizing high-power LED devices for desired uses.

2. Background

High intensity, LED devices present great challenges in managing the delivery of optical energy in a variety of useful applications. Even at relatively small distances such as 50 mm-150 mm, typical LED devices provide a greatly diminished optical energy that may be incapable of satisfying the requirements of a specific, intended application. The design of optical systems within LED devices requires the use of knowledge and tools to optimize the design to mitigate the reduction in optical power and boost the output of the LED device to useful levels.

### SUMMARY OF THE INVENTION

This invention substantially meets the aforementioned needs of the industry by providing a method of optimizing one or more light sources and one or more reflectors, the method including configuring the light source and reflector;

measuring light intensity and/or pattern generated by the configuration of the light source and reflector; and altering a distance between the light source and reflector and/or altering the reflector configuration; the cyclical configuring, measuring and altering continuing until the light intensity is maximized and/or until scattered light from the light pattern is minimized.

### BRIEF DESCRIPTION OF THE DRAWINGS

FIG. 1 is an illustration of an illumination pattern produced before optimization by the present invention.

FIG. 2 is a graph of the illumination intensity produced by the illumination pattern of FIG. 1.

FIG. 3 is an illustration of an illumination pattern produced after optimization by the present invention.

FIG. 4 is a graph of the illumination intensity produced by the illumination pattern of FIG. 3.

FIG. 5 is an illustration of another illumination pattern produced before optimization by the present invention.

FIG. 6 is an illustration of an illumination pattern produced after optimization by the present invention.

FIG. 7 is an ellipse describing a cross section of a parabolic reflector before optimization according to the present invention.

FIG. 8 is an ellipse describing a cross section of a parabolic reflector achieved after the ellipse of FIG. 7 was optimized according to the present invention.

FIG. 9 is a plan view showing three light source-reflector combinations and relational dimensions before being optimized by the present invention.

FIG. 10 is a plan view of the three light source-reflector combinations and relational dimensions thereof after being optimized by the present invention.

It is understood that the above-described figures are only illustrative of the present invention and are not contemplated to limit the scope thereof.

### DETAILED DESCRIPTION

Unless otherwise defined, all technical and scientific terms used herein have the same meaning as commonly understood by one of ordinary skill in the art to which this invention belongs. Although methods and materials similar or equivalent to those described herein can be used to practice the invention, suitable methods are described below. Each of the additional features and methods disclosed herein may be utilized separately or in conjunction with other features and methods to provide improved devices of this invention and methods for making and using the same. Representative examples of the teachings of the present invention, which examples utilize many of these additional features and methods in conjunction, will now be described in detail with reference to the drawings. However, this detailed description is merely intended to teach a person of skill in the art further details for practicing preferred aspects of the present teachings and is not intended to limit the scope of the invention. Therefore, only combinations of features and methods disclosed in the following detailed description may not be necessary to practice the invention in the broadest sense, and are instead taught merely to particularly describe representative and preferred embodiments of the invention.

A person of ordinary skill in the art will readily appreciate that individual components shown on various embodiments of the present invention are interchangeable to some extent and may be added or interchanged on other embodiments without departing from the spirit and scope of this invention.

In one embodiment, the method for optimizing the optical intensity is a combination of mechanical CAD design, ray-tracing computer software, and experimentation to verify the results. However, it is understood that each of the optimization protocols could be performed manually without using CAD software or ray-tracing software.

Typical mechanical means of design do not allow for very fine positioning and alignment of LED and reflector arrays. Utilizing the ray-tracing software in the case of a geometric shape, such as an ellipse, allows for the curved shape to be altered to the most beneficial value, considering all other design constraints. This can be used to increase the peak intensity, which occurs when one or more sources are focused to a point or along a line. The process of optimization conducted by the foregoing software may be performed with one or multiple parameters. For optical design, these parameters might include the uniformity of intensity, reducing the scattering angle, or altering the shape distribution of intensity over a given area. There are many methods which exist to perform an optimization scenario. One such method is to create a prototype and measure the desired parameters. Following measurement, the design is iterated (altered) and the test is performed again. The results are compared based against the previous test or tests, and then the design is changed again. This process is repeated until the desired parameter or parameters are altered to the desired levels. Another method is to simulate the design using computer software. The desired design is modeled and the optical properties are simulated using ray tracing software, which estimates the intensity and angular distribution of light emitted, reflected and absorbed on the designed surfaces. Once simulated, a design can be optimized multiple times prior to building a physical design, thus greatly reducing the time, effort, and resources expended for a physical optimization cycle.

The combination of computer software modeling allows for a variety of potential profiles that offer unique and flexible configuration depending on the application specific requirement of optical energy. Some processes require a short yet high intensity burst of energy, while some require lower peak intensity with a longer exposure time.

The embodiments of this device include one or more light source, such as LED, a single type of optical reflector or multiple types of reflectors that are capable of achieving the desired optical energy characteristics.

One suitable ray-tracing software is LightTools®, available from Synopsys Inc., 700 East Middlefield Road, Mountain View, Calif. 94043. Another suitable ray-tracing software is TracePro®, available from Lambda Research Corporation, 25 Porter Road, Littleton, Mass. 01460. Both take existing solid CAD models or approximations to create a physical space. Then a user enters known or estimated material properties such as reflectance, transmittance, and absorption for the solid, geometry to simulate light intensity and pattern on a target such as a substrate. The last step in setup is to use a “source” model based on previous (scientific) experience or data, to create a probabilistic emission of photons, including energy and direction. The software then estimates the behavior of this photon emission when the photon emission interacts with the previously modeled geometry. The software repeats such a calculation thousands to millions or more times, records the results and creates an estimated output. Depending on the desired optimization parameters, for example increasing intensity, the software makes a change to the geometric shape of the reflector(s) or position of the reflector(s) relative to the light source(s), then repeats the calculation and compares to the previous value. The software repeats this process until a desired “convergence criteria” is achieved, often a small change in output from one step to the next. It is necessary to understand the basic geometry and source model to create the best results and to achieve a solution that applies in a manufacturing setting.

### EXAMPLE 1

### Shape Optimization for Increased Intensity

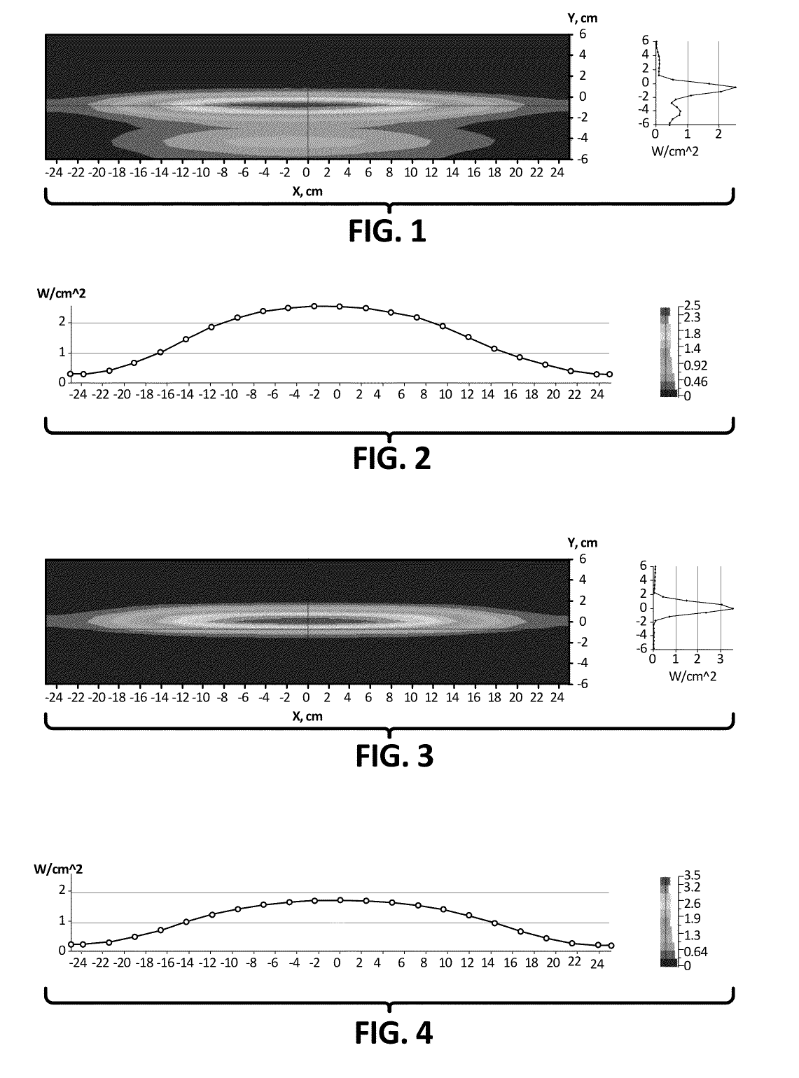

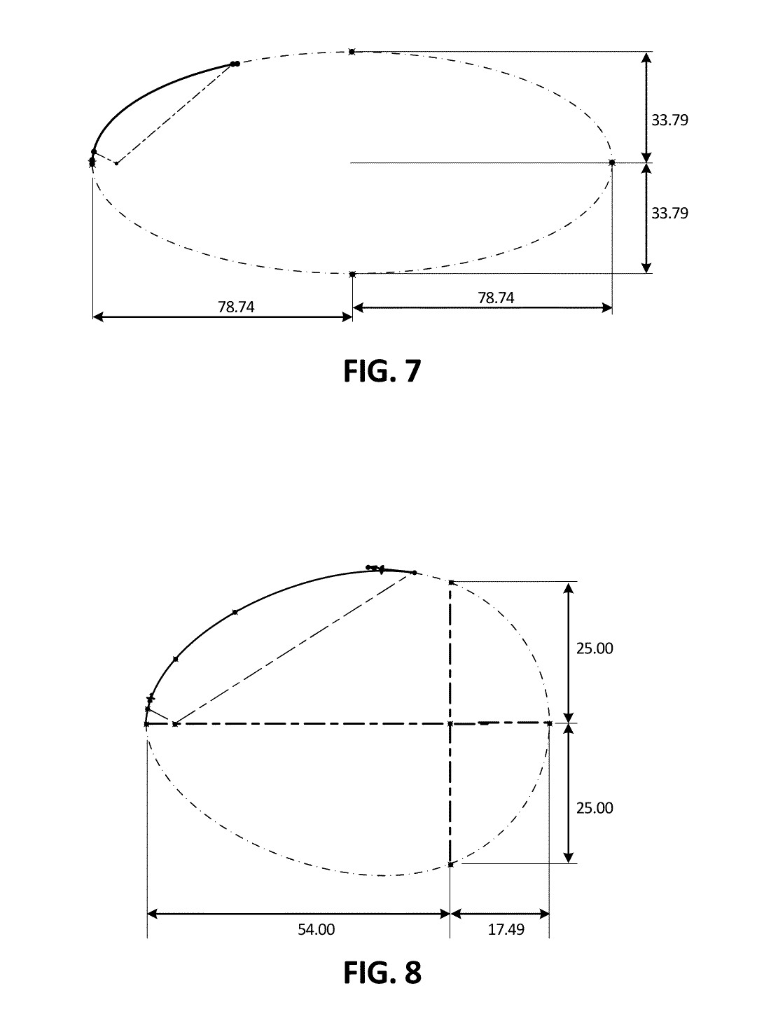

In this example a parabolic reflector was optimized to remove unfocused light and increase the intensity of the irradiation pattern, as seen in FIGS. 1, 2 as a secondary ellipse. The shape of the parabolic reflector was altered to provide a better illumination profile to reduce scattered light. Optimization software was used to change the shape parameters of the ellipse (parabolic reflector) as necessary to maximize the intensity. This could have alternately been achieved by manufacturing a different ellipse shape and testing the radiometric output, and repeating until a maximum intensity was found. The resulting ellipse shown in FIGS. 3, 4 had a narrower focus than would be assumed from pure scientific approximation. As shown in FIG. 1, the intensity before optimization was approximately 2.5 W/cm². Reconfiguring the shape of the parabolic reflector and maintaining the original distances between the light source and reflector provided an intensity of about 3.5 W/cm² as shown in FIG. 3. Moreover, the scattered light, shown as a “shadow” beneath the focus along the 0Y axis, was eliminated. One method of improving the focus of an elliptical reflector is to alter the curvature of the ellipse that describes the cross-section. The original ellipse, which describes the system as the source at one focus of the ellipse and the other focus is at the imaging surface. Referring to FIGS. 7, 8, cross-sections of respective beginning and final optimized reflector shapes are shown with dimensions (mm). The optimized reflector shape had a longitudinal dimension decrease of from 78.74 mm, 78.74 mm to 54.00 mm, 17.49 mm and a lateral dimension decrease of from 33.79 mm, 33.79 mm to 25.00 mm, 25.00 mm. Accordingly the focus-optimized ellipse of FIG. 8 had a modified curvature from the beginning ellipse of FIG. 7. Stated otherwise, the focus-optimized ellipse is of FIG. 8 is shown with the curvature modified.

### EXAMPLE 2

### Position Optimization for Uniform Profile

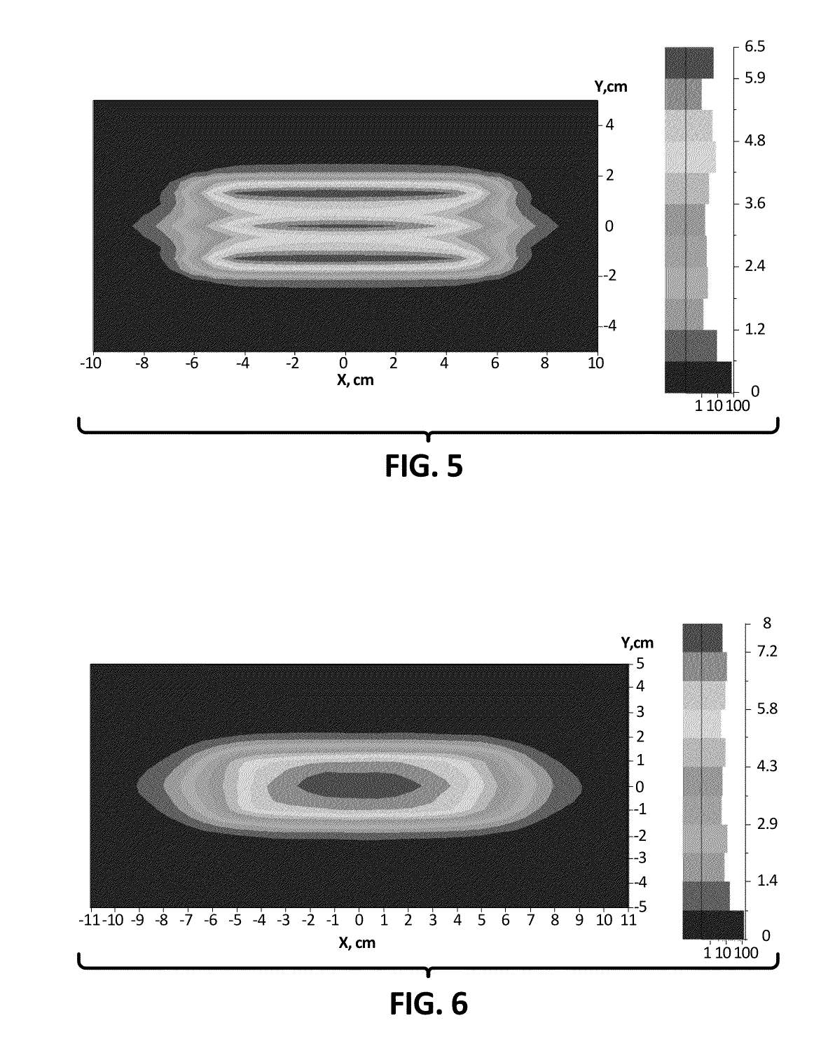

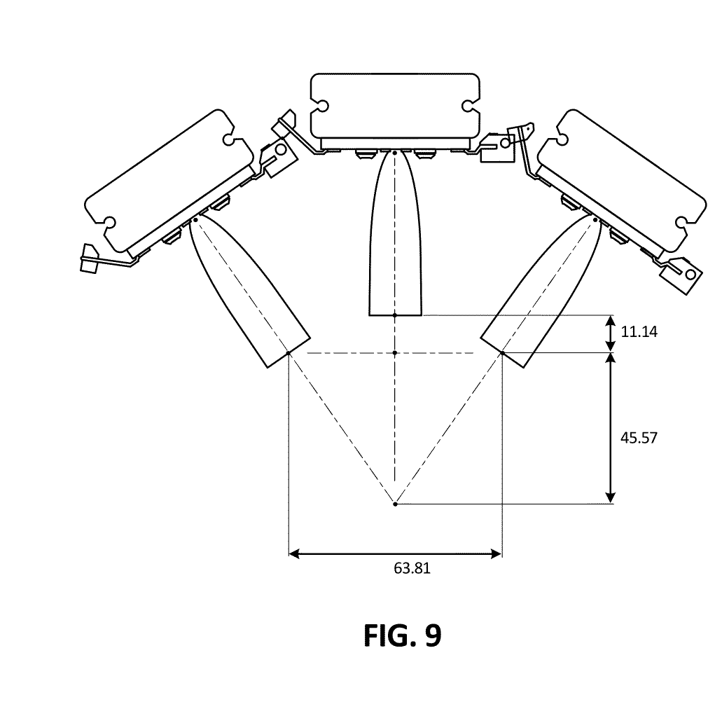

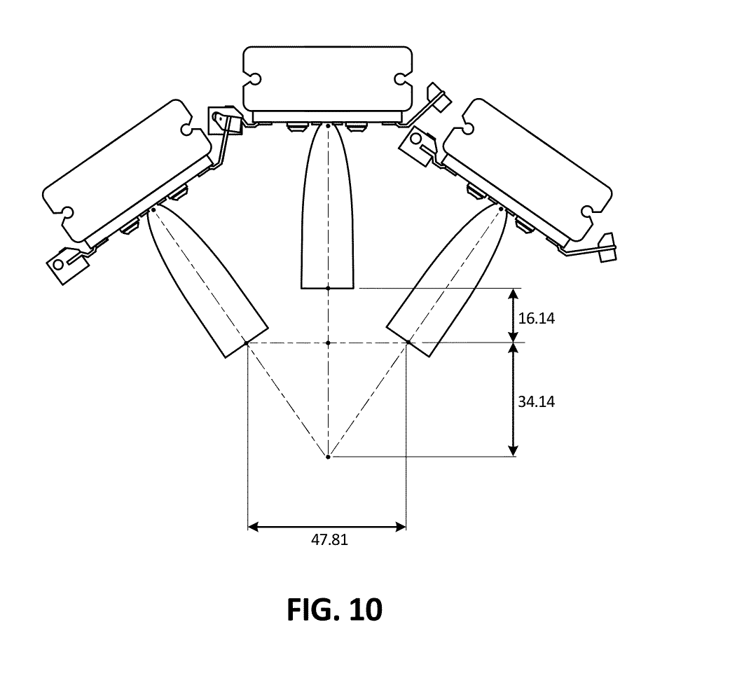

In a second example, multiple reflectors were desired to illuminate uniformly. The optimization used altered the position of the reflector assemblies, rather than the reflector shapes, until there was a uniform profile along the center line (Y=0). In this example three reflector assemblies, comprising a row of LED sources and an elliptical reflector, were optimized to create a large plateau-shape profile, which is ideal for a process requiring a large dose of irradiation. In this situation, three assemblies require position optimization in two dimensions to create the desired uniform profile. To achieve this purely mechanically, would require manual positioning the three assemblies and testing the irradiation profile. Afterwards, repositioning the assemblies and then retesting the irradiation profile. This process would be repeated until the profile exhibited the desired optical uniformity. As seen in FIG. 9, exemplary light source-reflector combinations before being optimized have relational dimensions of 11.14 mm, 45.57 mm, and 63.81 mm and provide the illumination profile depicted in FIG. 5. After being optimized to respective dimensions 16.14 mm, 34.14 mm, and 47.81 mm of FIG. 10, the illumination profile of FIG. 6 is realized.

The light intensity of a light source-reflector combination is maximized when no greater intensity can be achieved by altering the reflector configurationa or distance between the reflector and the light source. The light pattern of a light source-reflector combination is minimized when no lesser amount of scattered light is emitted by altering the reflector configuration or distance between the reflector and the light source. A combination of one or more light sources and one or more reflectors is optimized when light intensity therefrom is maximized and/or when the light pattern therefrom is minimized.

Because numerous modifications of this invention may be made without departing from the spirit thereof, the scope of the invention is not to be limited to the embodiments illustrated and described. Rather, the scope of the invention is to be determined by the appended claims and their equivalents.

What is claimed is:

1. A method of optimizing an light source and reflector, comprising cyclically:
configuring said light source and reflector;
measuring light intensity and pattern generated by said configuration of said light source and reflector; and
altering a distance between said light source and reflector or said reflector configuration;
said cyclical configuring, measuring and altering continuing until said light intensity is maximized or until scattered light from said light pattern is minimized.

2. The method of claim 1, wherein said light source includes a light emitting diode.

3. The method of claim 1, wherein said reflector is substantially parabolic.

4. The method of claim 1, wherein said reflector is altered and said distance between said light source and said reflector configuration is constant.

5. The method of claim 1, wherein said distance between said light source and said reflector is altered and said reflector configuration is constant.

6. The method of claim 1, wherein said cyclical configuring, measuring and altering continues until light intensity is maximized.

7. The method of claim 1, wherein said cyclical configuring, measuring and altering continues until scattered light is minimized.

8. The method of claim 1, wherein a plurality of reflectors are optimized.

9. An optimized light source and reflector made from the method of claim 1.

10. The optimized light source and reflector of claim 9, wherein said reflector configuration has been altered.

11. The optimized light source and reflector of claim 10, wherein configuration of a plurality of reflectors is altered.

12. The optimized light source and reflector of claim 9, wherein said distance between said light source and said reflector has been altered.

13. The optimized light source and reflector of claim 9, wherein light intensity has been maximized.

14. The optimized light source and reflector of claim 9, wherein said scattered light has been minimized.

15. A method of curing an ink printed on a substrate, comprising directing light at such substrate from said light source and said reflector optimized by the method of claim 1.

16. The method of claim 15, wherein said reflector configuration has been altered.

17. The method of claim 15, wherein said distance between said light source and said reflector has been altered.

18. The method of claim 15, wherein light intensity has been maximized.

19. The method of claim 15, wherein said scattered light has been minimized.

20. The method of claim 15, wherein said light emanates from a light emitting diode.
